(19) United States
(12) Patent Application Publication
(10) Pub. No.: US 2024/0393809 A1
(43) Pub. Date: Nov. 28, 2024

(54) METHOD OF DETERMINING PRIORITY AMONG PLURALITY OF MOBILE ROBOTS AND APPARATUS FOR PERFORMING THE SAME

(71) Applicant: Electronics and Telecommunications Research Institute, Daejeon (KR)

(72) Inventors: Taehyoung SHIM, Sejong-si (KR); Jun Seob LEE, Daejeon (KR); Jeongil YIM, Daejeon (KR)

(73) Assignee: Electronics and Telecommunications Research Institute, Daejeon (KR)

(21) Appl. No.: 18/671,575

(22) Filed: May 22, 2024

(30) Foreign Application Priority Data
May 26, 2023 (KR) 10-2023-0068307
Feb. 5, 2024 (KR) 10-2024-0017492

(51) Int. Cl. G05D 1/698; G05D 105/28

(52) U.S. Cl. CPC G05D 1/698; G05D 2105/28

(57) ABSTRACT

A method of determining priority among a plurality of mobile robots is provided. The method includes detecting a second mobile robot that shares a space with a first mobile robot, exchanging a first consensus policy of the first mobile robot for a second consensus policy of the second mobile robot, and controlling movement of the first mobile robot according to a moving method determined based on the first consensus policy and the second consensus policy.

### CROSS-REFERENCE TO RELATED APPLICATION

This application claims the benefit of Korean Patent Application No. 10-2023-0068307 filed on May 26, 2023 and 10-2024-0017492 filed on Feb. 5, 2024, in the Korean Intellectual Property Office, the entire disclosures of which are incorporated herein by reference for all purposes.

### BACKGROUND

### 1. Field of the Invention

One or more embodiments relate to a method of determining priority among a plurality of mobile robots and an apparatus for performing the same.

### 2. Description of the Related Art

A mobile robot is a robot that may move without being limited to a fixed location. A mobile robot may be remotely controlled, or it may move on its own. An autonomous delivery robot service may refer to a service in which a delivery robot delivers goods by interworking with urban infrastructure and other entities.

For the autonomous delivery robot service, an interworking protocol between the entities (e.g., a delivery robot, a service provider, a user, and infrastructure) may be needed.

The above description has been possessed or acquired by the inventor(s) in the course of conceiving the present disclosure and is not necessarily an art publicly known before the present application is filed.

### SUMMARY

Embodiments provide technology for reaching an agreement on priority among a plurality of mobile robots.

Embodiments provide technology to address congestion among a plurality of mobile robots managed by different service providers.

However, the technical aspects are not limited to the aforementioned aspects, and other technical aspects may be present.

According to an aspect, there is provided a method including detecting a second mobile robot that shares a space with a first mobile robot, exchanging a first consensus policy of the first mobile robot for a second consensus policy of the second mobile robot, and controlling movement of the first mobile robot according to a moving method determined based on the first consensus policy and the second consensus policy.

The exchanging of the first consensus policy for the second consensus policy may include determining whether the first consensus policy and the second consensus policy are a cooperation policy.

The moving method may be determined to be a first moving method when the first consensus policy and the second consensus policy are the cooperation policy and may be determined to be a second moving method when at least one of the first consensus policy and the second consensus policy is a competition policy.

The first moving method may be based on priority related to an order of movement between the first mobile robot and the second mobile robot.

The priority may be determined based on a first value function corresponding to the first mobile robot and a second value function corresponding to the second mobile robot.

The first value function may be determined based on a service providing time of the first mobile robot, and the second value function may be determined based on a service providing time of the second mobile robot.

The priority may be determined based on a first value of the first mobile robot according to the first value function and a second value of the second mobile robot according to the second value function.

The first value may be determined based on on a user's satisfaction level according to a service providing time of the first mobile robot and the first value function, and the second value may be determined based on a user's satisfaction level according to a service providing time of the second mobile robot and the second value function.

The priority may be determined so that a sum of the first value and the second value may be maximized.

According to another aspect, there is provided an apparatus including a memory including instructions and a processor electrically connected to the memory and configured to execute the instructions, wherein, when the instructions are executed by the processor, the processor is configured to control a plurality of operations, wherein the plurality of operations include detecting a second mobile robot that shares a space with a first mobile robot, exchanging a first consensus policy of the first mobile robot for a second consensus policy of the second mobile robot, and controlling movement of the first mobile robot according to a moving method determined based on the first consensus policy and the second consensus policy.

The exchanging of the first consensus policy for the second consensus policy may include determining whether the first consensus policy and the second consensus policy are a cooperation policy.

The moving method may be determined to be a first moving method when the first consensus policy and the second consensus policy are the cooperation policy and may be determined to be a second moving method when at least one of the first consensus policy and the second consensus policy is a competition policy.

The first moving method may be based on priority related to an order of movement between the first mobile robot and the second mobile robot.

The priority may be determined based on a first value function corresponding to the first mobile robot and a second value function corresponding to the second mobile robot.

The first value function may be determined based on a service providing time of the first mobile robot, and the second value function may be determined based on a service providing time of the second mobile robot.

The priority may be determined based on a first value of the first mobile robot according to the first value function and a second value of the second mobile robot according to the second value function.

The first value may be determined based on a user's satisfaction level according to a service providing time of the first mobile robot and the first value function, and the second value may be determined based on a user's satisfaction level according to a service providing time of the second mobile robot and the second value function.

The priority may be determined so that a sum of the first value and the second value may be maximized.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIGS. 1 and 2 are diagrams illustrating a delivery robot service system;

FIG. 3 is a flowchart schematically illustrating a workflow of a delivery robot service, according to an embodiment;

FIGS. 4A and 4B are diagrams illustrating a situation in which a plurality of mobile robots share a space, according to an embodiment;

FIG. 5 is a diagram illustrating a method of controlling movement of a mobile robot, according to an embodiment;

FIG. 6 is a diagram illustrating a value function according to an embodiment;

FIG. 7 is a diagram illustrating an operation of deriving a priority, according to an embodiment;

FIG. 8 is a flowchart illustrating a method of controlling movement of a mobile robot, according to an embodiment;

FIG. 9 is a block diagram schematically illustrating a mobile robot according to an embodiment;

FIG. 10 is a block diagram schematically illustrating a service provider according to an embodiment; and

FIG. 11 is a block diagram schematically illustrating an apparatus for controlling movement of a mobile robot, according to an embodiment.

### DETAILED DESCRIPTION

The following structural or functional description of embodiments is provided as an example only and various alterations and modifications may be made to the embodiments. Thus, an actual form of implementation is not construed as limited to the embodiments described herein and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. As used herein, each of “A or B,” “at least one of A and B,” “at least one of A or B,” “A, B, or C,” “at least one of A, B, and C,” “at least one of A, B, or C,” and the like may include any one of the items listed together in the corresponding one of the phrases, or all possible combinations thereof. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry.” A module may be a single integral component or a minimum unit or part thereof, adapted to perform one or more functions. For example, according to an embodiment, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments are described in detail with reference to the accompanying drawings. When describing the examples with reference to the accompanying drawings, like reference numerals refer to like components and a repeated description related thereto is omitted.

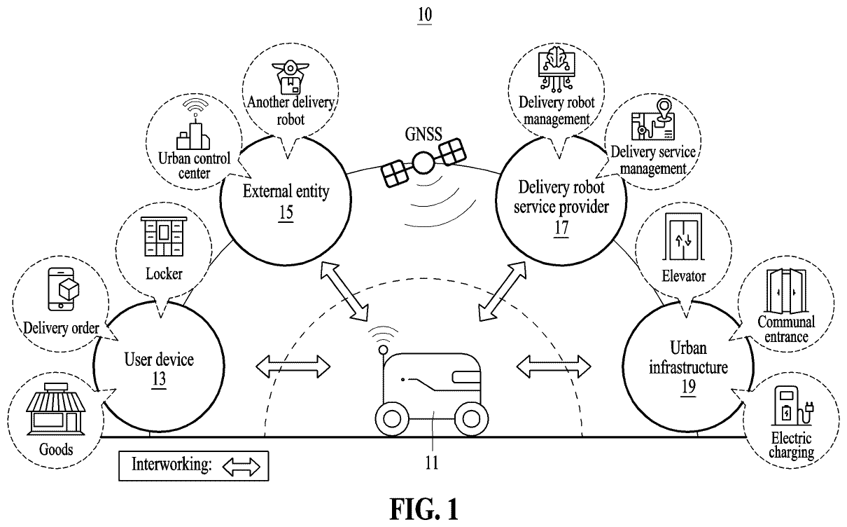

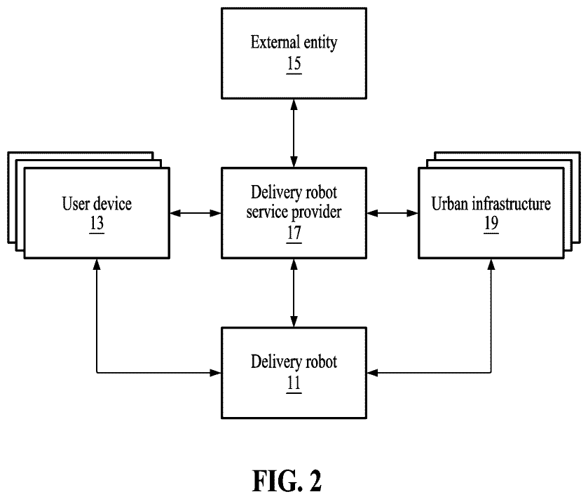

FIGS. 1 and 2 are diagrams illustrating a delivery robot service system.

Referring to FIGS. 1 and 2, a delivery robot service system 10 may include a delivery robot 11, a user device 13, an external entity 15, a delivery robot service provider 17, and urban infrastructure 19.

The delivery robot 11 may deliver goods based on a delivery request of a user. The delivery robot 11 may include an autonomous driving-based robot. The delivery robot 11 may directly interwork with the user device 13, the delivery robot service provider 17, and the urban infrastructure 19. The delivery robot 11 may indirectly interwork with the external entity 15 through the delivery robot service provider 17.

The delivery robot 11 may share information (e.g., an identifier and capabilities) on the delivery robot 11 with the delivery robot service provider 17.

The delivery robot 11 may share delivery status information (e.g., a current location of the delivery robot 11, a goods loading status, a type of goods, and a status of the goods) with the delivery robot service provider 17.

The delivery robot 11 may identify at least one user device associated with the goods to be delivered. For example, the delivery robot 11 may identify a user device (e.g., a user device of a sender of the goods) associated with loading of the goods and a user device (e.g., a user device of a receiver of the goods) associated with unloading of the goods.

When the goods are loaded or unloaded by an object (e.g., a person or another robot) that is not the delivery robot 11, the delivery robot 11 may, after the delivery robot 11 arrives at a pick-up location or a delivery location, notify the delivery robot service provider 17 that the delivery robot 11 is waiting for the loading or the unloading of the goods.

The delivery robot 11 may receive information indicating that the loading or the unloading is completed from the object (e.g., a person or another robot) responsible for the loading or the unloading of the goods. After receiving the information, the delivery robot 11 may notify the delivery robot service provider 17 that the loading or the unloading is completed.

When the goods are loaded or unloaded by the delivery robot 11, the delivery robot 11 may, after completing the loading or the unloading of the goods, notify the delivery robot service provider 17 that the loading or the unloading is completed.

After arriving at the urban infrastructure 19, the delivery robot 11 may notify the delivery robot service provider 17 that the delivery robot 11 is waiting to access the urban infrastructure 19.

The delivery robot 11 may request the delivery robot service provider 17 to transmit additional information needed for autonomous driving or to access the urban infrastructure 19.

The delivery robot 11 may maintain time synchronization with the delivery robot service provider 17.

When an event (e.g., a breakdown of the delivery robot 11) that may impede delivery occurs, the delivery robot 11 may notify the delivery robot service provider 17 of information related to the event. The delivery robot 11 may take an action needed to resolve the event.

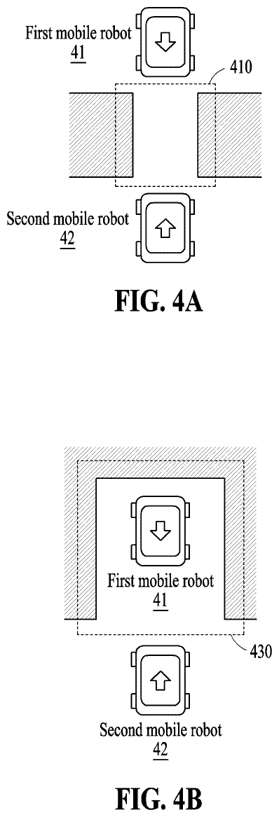

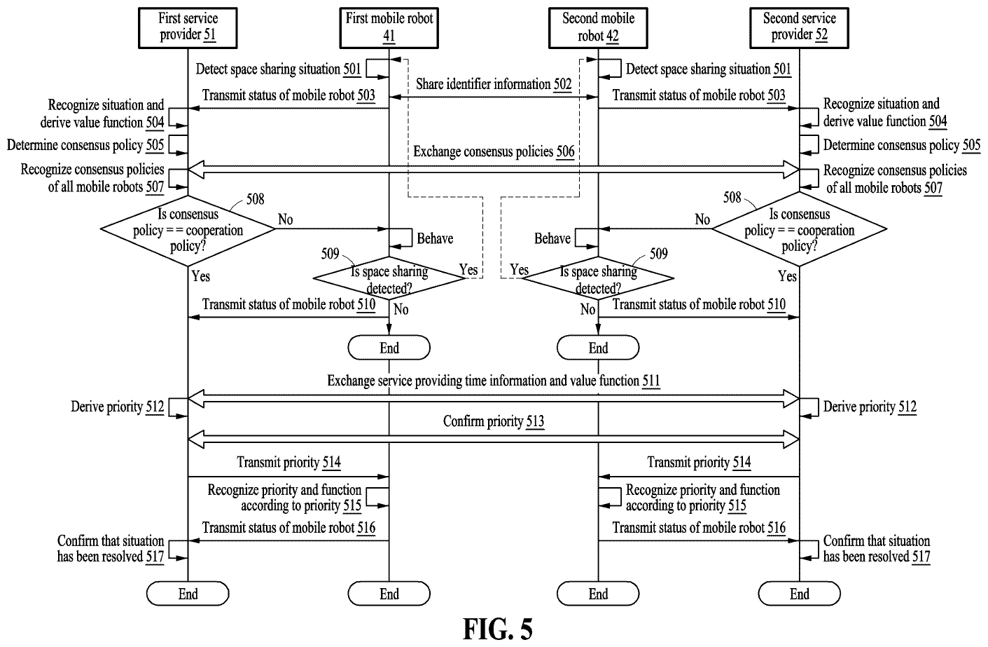

The delivery robot 11 may directly interwork with the user device 13, the urban infrastructure 19, and another delivery robot (e.g., another delivery robot and a second mobile robot 42 of FIG. 5), as needed. For example, the delivery robot 11 may directly interwork with the another delivery robot when a collision with the another delivery robot that is within a preset distance (or a distance that may be sensed by a sensor) from the delivery robot 11 is predicted. The delivery robot 11 may directly interwork with the another delivery robot when congestion is predicted due to sharing a small space (e.g., a moving space 410 of FIG. 4A and a stationary space 430 of FIG. 4B) with the another delivery robot. The delivery robot 11 may calculate a congestion level based on at least one of an area of a surrounding space of the delivery robot 11, a type of the surrounding space of the delivery robot 11, a size of the delivery robot 11, or a size of the another delivery robot. For example, the delivery robot 11 may determine the congestion level to be higher when a possibility of the surrounding space (e.g., an elevator) of the delivery robot 11 being occupied by a person is higher. The delivery robot 11 may directly interwork with the another delivery robot when the congestion level satisfies a threshold (e.g., when the congestion level is greater than or equal to a predetermined threshold value). The delivery robot 11 may directly interwork with the urban infrastructure 19 when a failure occurs in communication with the delivery robot service provider 17. The delivery robot 11 may directly interwork with the user device 13 when the delivery robot 11 needs to move to a location in proximity to the user device 13, or when user authentication is required.

The delivery robot 11 may notify the delivery robot service provider 17 of a result of direct interworking.

The delivery robot 11 may interwork with the another delivery robot through the delivery robot service provider 17.

The delivery robot 11 may receive, from the delivery robot service provider 17, a request to preferentially process a certain task. The delivery robot 11 may preferentially process the requested task. The delivery robot 11 may transmit a result of processing the requested task to the delivery robot service provider 17.

The user device 13 may include at least one device. For example, the user device 13 may include at least one of a device of a delivery requester, a device associated with the loading of the goods, or a device associated with the unloading of the goods. The device may include an electronic device that is operated by a user, such as a mobile device and a computing device, and/or an unattended electronic device that may store and/or manage the goods. The user device 13 may directly interwork with the delivery robot service provider 17 and the delivery robot 11.

The user device 13 may provide a function (e.g., a user interface) to receive a delivery request from the user and to provide the delivery status information to the user.

The user device 13 may transmit delivery information input by the user to the delivery robot service provider 17.

The user device 13 may collect location information of the user device 13.

When receiving information that needs to be confirmed or processed by the user, the user device 13 may notify the user of the reception of the information using various means (e.g., sound, vibration, or light).

The user device 13 may directly interwork with the delivery robot 11 that is located in the vicinity of the user device 13. For example, the user device 13 may directly interwork with the delivery robot 11 when the delivery robot 11 is located within a preset distance from the user device 13.

The user device 13 may notify a user (e.g., a pick-up person and a goods receiver) when a request for the loading or the unloading of the goods is received from the delivery robot service provider 17.

The user device 13 may notify the delivery robot service provider 17 of completion of the loading or the unloading of the goods.

The external entity 15 may include a device (e.g., a server) of a public institution (e.g., an urban control center, a disaster management agency, and an emergency rescue agency) and a device (e.g., a server) of another delivery robot service provider. The external entity 15 may directly interwork with the delivery robot service provider 17.

The delivery robot service provider 17 may include a device, such as a server. The delivery robot service provider 17 may manage the delivery robot 11. The delivery robot service provider 17 may directly interwork with the delivery robot 11, the user device 13, the external entity 15, and the urban infrastructure 19.

The delivery robot service provider 17 may retain and/or manage the information (e.g., the identifier and the capabilities) on the delivery robot 11.

The delivery robot service provider 17 may collect and manage information (e.g., a location, an identifier, and capabilities) on the urban infrastructure 19.

The delivery robot service provider 17 may determine a presence of an available delivery robot (e.g., the delivery robot 11) in response to receiving a delivery request from the user device 13. The delivery robot service provider 17 may transmit information (e.g., approving a delivery request and rejecting a delivery request) to the user device 13 based on a determination result of the presence of an available delivery robot.

The delivery robot service provider 17 may identify at least one user device associated with the received delivery request. For example, the delivery robot service provider 17 may identify a user device of the delivery requester, the user device associated with the loading of the goods, and the user device associated with the unloading of the goods (e.g., the user device of the receiver of the goods).

The delivery robot service provider 17 may generate delivery information on the delivery request. The delivery information may include at least one of a pick-up location, a delivery location, a delivery time, information (e.g., a location and an identifier) on infrastructure that needs to interwork with a delivery robot, a delivery route, a type of goods, a weight of the goods, a size of the goods, and a delivery condition (e.g., a proper temperature, such as room temperature, refrigeration, and freezing).

The delivery robot service provider 17 may assign the delivery robot 11 for the delivery request simultaneously with or separately from generating the delivery request.

The delivery robot service provider 17 may collect the current location of the delivery robot 11, a movement direction of the delivery robot 11, a status (e.g., breakdown and a battery status) of the delivery robot 11, the goods loading status of the delivery robot 11, and the status (e.g., a temperature) of the goods.

The delivery robot service provider 17 may transmit the delivery status information generated by the delivery robot 11 to the user device 13.

After the delivery robot 11 arrives at the pick-up location or the delivery location, the delivery robot service provider 17 may notify the user device 13 that the delivery robot 11 is waiting to load or unload the goods.

After the delivery robot 11 arrives at the urban infrastructure 19, the delivery robot service provider 17 may notify the urban infrastructure 19 that the delivery robot 11 is waiting to interwork with the urban infrastructure 19.

The delivery robot service provider 17 may need to notify the delivery robot 11 of a response (e.g., a result of an interworking request), which is received from the urban infrastructure 19, to the interworking request.

The delivery robot service provider 17 may collect additional information other than the delivery information from the urban infrastructure 19 and/or the external entity 15. The delivery robot service provider 17 may provide the collected additional information to the delivery robot 11.

The delivery robot service provider 17 may receive information indicating that the loading or the unloading of the goods is completed from the user device 13. The delivery robot service provider 17 may transmit the received information to the delivery robot 11.

The delivery robot service provider 17 may receive information indicating that the loading or the unloading of the goods is completed from the delivery robot 11. The delivery robot service provider 17 may transmit the received information to the user device 13.

The delivery robot service provider 17 may determine whether the delivery robot 11 may continue to deliver the goods, based on the delivery status information generated by the delivery robot 11.

The delivery robot service provider 17 may receive a result of direct interworking from the delivery robot 11. The delivery robot service provider 17 may update the delivery information in response to receiving the result.

The delivery robot service provider 17 may receive a request from the external entity 15. For example, the external entity 15 may request the delivery robot service provider 17 to transmit visual information on the surrounding space of the delivery robot 11. The delivery robot service provider 17 may evaluate (or determine) the request (e.g., contents of the request) from the external entity 15. The delivery robot service provider 17 may divide the request from the external entity 15 into an urgent request and a non-urgent request. The delivery robot service provider 17 may notify the delivery robot 11 of the request from the external entity 15. For example, when the request from the external entity 15 needs to be processed preferentially, the delivery robot service provider 17 may transmit priority information of the request together with the request from the external entity 15 to the delivery robot 11.

The delivery robot service provider 17 may process the request from the external entity 15 and notify the external entity 15 of a processing result.

The delivery robot service provider 17 may determine a priority among a plurality of delivery robots when the plurality of delivery robots is waiting to interwork with a same urban infrastructure. The priority may be an order in which the plurality of delivery robots is to use the urban infrastructure. The delivery robot service provider 17 may use the delivery status information (e.g., the type of goods and the status of the goods) of each of the plurality of delivery robots to determine the priority.

The delivery robot service provider 17 may receive, from the delivery robot 11, a result of interworking (e.g., direct interworking) between the delivery robot 11 and the another delivery robot. The delivery robot service provider 17 may determine, from the received result, that the another delivery robot is managed by the another delivery robot service provider. The delivery robot service provider 17 may determine, from the received result, that the delivery robot 11 and the another delivery robot are waiting to interwork with the same urban infrastructure. The delivery robot service provider 17 may interwork with the another delivery robot service provider to coordinate a priority between the delivery robot 11 and the another delivery robot.

The delivery robot service provider 17 may transform a certain coordinate system (e.g., a Cartesian coordinate system) into another coordinate system (e.g., a spherical coordinate system). The delivery robot service provider 17 may determine the current location of the delivery robot 11 using an appropriate coordinate system. The delivery robot service provider 17 may use an appropriate coordinate system to assist in an operation (e.g., the loading and the unloading of the goods or an access to the urban infrastructure 19) of the delivery robot 11. The delivery robot service provider 17 may use an appropriate coordinate system to exchange information with the another delivery robot service provider.

The urban infrastructure 19 may include facilities (e.g., an elevator, a gate, a communal entrance, and an electric charging station) that need to be used, accessed, and/or passed by the delivery robot 11 to deliver the goods. The urban infrastructure 19 described herein may be a device (e.g., a server) that manages the urban infrastructure 19. The urban infrastructure 19 may directly interwork with the delivery robot 11 and the delivery robot service provider 17.

The urban infrastructure 19 may share the information (e.g., the identifier, the capabilities, and the location) on the urban infrastructure 19 with the delivery robot service provider 17.

The urban infrastructure 19 may notify the delivery robot service provider 17 whether the access of the delivery robot 11 is approved.

The urban infrastructure 19 may request the delivery robot service provider 17 to transmit information on goods loaded on the delivery robot 11.

The urban infrastructure 19 may directly interwork with the delivery robot service provider 17. The urban infrastructure 19 may interwork with the delivery robot service provider 17 through another system (e.g., a building management system and an external infrastructure management service system).

The urban infrastructure 19 may directly interwork with the delivery robot 11 located near the urban infrastructure 19.

The urban infrastructure 19 may provide, in response to a request from the delivery robot service provider 17, the information (e.g., a service status, availability, breakdown, or inspection) on the urban infrastructure 19 to the delivery robot service provider 17.

The delivery robot service system 10 may include a data security means (e.g., communication encryption) for interworking.

The delivery robot service system 10 may include a means to prevent data forgery for interworking.

The delivery robot service system 10 may include a means to prevent leakage of personal information of the user and location information of the user.

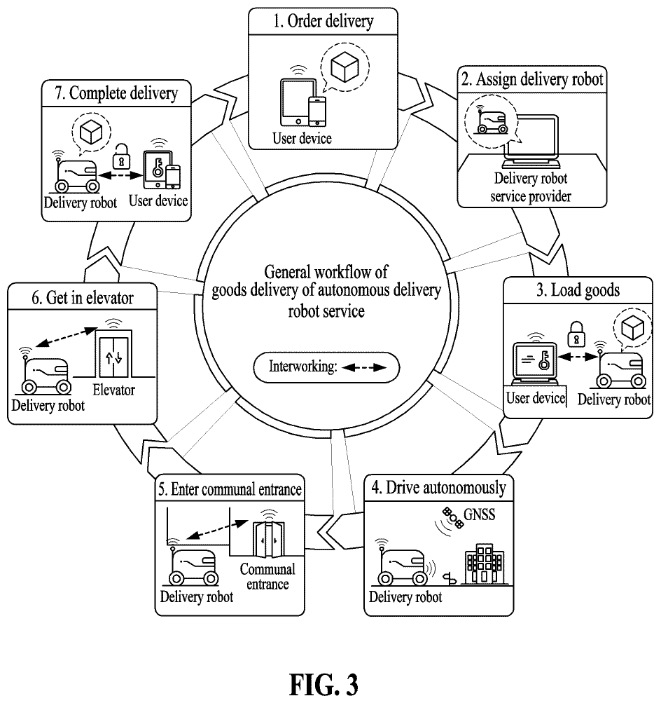

FIG. 3 is a flowchart schematically illustrating a workflow of a delivery robot service, according to an embodiment.

Referring to FIG. 3, a user device (e.g., the user device 13 of FIG. 1) may transmit a delivery request from a user to a delivery robot service provider (e.g., the delivery robot service provider 17 of FIG. 1).

The delivery robot service provider 17 may confirm the delivery request and assign a delivery robot (e.g., the delivery robot 11 of FIG. 1) to perform the delivery.

The delivery robot 11 may move to a pick-up location of goods through autonomous driving. The delivery robot 11 may interwork with the user device 13 to load the goods.

The delivery robot 11 may move to a destination (e.g., a delivery location) together with the loaded goods through autonomous driving.

The delivery robot 11 may interwork with urban infrastructure (e.g., the urban infrastructure 19 of FIG. 1) located on a delivery route. For example, the delivery robot 11 may communicate with management systems (e.g., a server) of a communal entrance and an elevator to use the communal entrance and the elevator.

After arriving at the destination, the delivery robot 11 may unload the goods. The delivery robot 11 may interwork with the user device 13 to unload the goods.

FIGS. 4A and 4B are diagrams illustrating a situation in which a plurality of mobile robots share a space, according to an embodiment.

Referring to FIG. 4A and FIG. 4A, a mobile robot may be a movable robot that is not fixed in a location on the ground. The mobile robot may include an outdoor mobile robot, a delivery robot (e.g., the delivery robot 11 of FIG. 1), and an autonomous mobile robot. The mobile robot may control its own movement, or the movement of the mobile robot may be remotely controlled by a service provider (e.g., the delivery robot service provider 17 of FIG. 1) that manages the mobile robot. Depending on a type of mobile robot, the mobile robot may provide various services to a user, such as delivery, patrol, and epidemic prevention.

The plurality of mobile robots may include a first mobile robot 41 and a second mobile robot 42. The first mobile robot 41 and the second mobile robot 42 may each be the delivery robot 11 described with reference to FIGS. 1 to 3.

The first mobile robot 41 and the second mobile robot 42 may share a space (e.g., the urban infrastructure 19 of FIG. 1). For example, when the first mobile robot 41 and the second mobile robot 42 are to use a same urban infrastructure (e.g., when the first mobile robot 41 and the second mobile robot 42 are waiting to interconnect with the same urban infrastructure), a space sharing situation between the first mobile robot 41 and the second mobile robot 42 may occur. The space may include a moving space 410 and a stationary space 430. The moving space 410 may include a space located on a moving route of the mobile robot (e.g., the first mobile robot 41). For example, the moving space 410 may include a space such as a hallway, a communal entrance, and an elevator door. The stationary space 430 may include a space in which a mobile robot (e.g., the first mobile robot 41) needs to stay to perform a specific task (e.g., loading, unloading, and vertical movement). For example, the stationary space 430 may include a space such as a pick-up location, a delivery location, and an interior of an elevator.

The first mobile robot 41 and the second mobile robot 42 may be operated (e.g., managed) by different service providers. For example, a first service provider that manages the first mobile robot 41 (e.g., a first service provider 51 of FIG. 5) may be different from a second service provider that manages the second mobile robot 42 (e.g., a second service provider 52 of FIG. 5). The first service provider 51 and the second service provider 52 may each include a device such as a server.

The first mobile robot 41 may detect the second mobile robot 42 that shares a space with the first mobile robot 41. When the first mobile robot 41 and the second mobile robot 42 share a space, congestion or a collision may occur due to independent behaviors of each of the first mobile robot 41 and the second mobile robot 42. For example, when both the first mobile robot 41 and the second mobile robot 42 competitively attempt to obtain a space (e.g., the moving space 410 and the stationary space 430), a collision between the first mobile robot 41 and the second mobile robot 42 may occur. In another example, when both the first mobile robot 41 and the second mobile robot 42 are waiting to yield a space (e.g., the moving space 410 and the stationary space 430) to the other mobile robot, congestion may occur as a provision of service is delayed. When congestion or a collision occurs between a plurality of mobile robots operated by a same service provider, traffic management may be performed by the service provider. The traffic management may be performed based on an agreement on priority related to an order of movement between the plurality of mobile robots. A traffic management method may be required to prevent congestion or a collision between a plurality of mobile robots operated by different service providers.

FIG. 5 is a diagram illustrating a method of controlling movement of a mobile robot, according to an embodiment.

Referring to FIG. 5, the first service provider 51 and the second service provider 52 may each include the delivery robot service provider 17 described with reference to FIGS. 1 to 3. The first service provider 51 may manage the first mobile robot 41. The second service provider 52 may manage the second mobile robot 42. The first service provider 51 and the second service provider 52 may directly interwork with each other to prevent and/or resolve the occurrence of congestion or a collision due to space sharing between the first mobile robot 41 and the second mobile robot 42. The first service provider 51 may exchange a first consensus policy of the first mobile robot 41 for a second consensus policy of the second mobile robot 42 of the second service provider 52. The first service provider 51 may determine a moving method of a plurality of mobile robots (e.g., the first mobile robot 41 and the second mobile robot 42) based on each of the first and second consensus policies.

Operations 501 to 517 may be substantially the same as the method of controlling movement of a mobile robot according to an embodiment. The method may be performed by a processor (e.g., a processor 920 of FIG. 9) mounted on a mobile robot (e.g., the first mobile robot 41 and the second mobile robot 42) and/or a mobile robot service provider (e.g., the first service provider 51 and the second service provider 52). Operations 510 to 517 may be performed sequentially, but embodiments are not limited thereto. For example, one or more operations may be omitted or added, or two or more operations may be performed in parallel.

Hereinafter, for ease of description, the process through which operations 501 to 517 are performed is described relative to the first mobile robot 41 and the first service provider 51. However, it should be noted that operations 501 to 517 may be performed between the first mobile robot 41, the first service provider 51, the second mobile robot 42, and the second service provider 52.

In operation 501, the first mobile robot 41 may detect a space sharing situation with the second mobile robot 42. The first mobile robot 41 may calculate a congestion level based on at least one of an area of a space, a type of space, a size of the first mobile robot 41, or a size of the second mobile robot 42. The first mobile robot 41 may determine that the first mobile robot 41 is sharing the space with the second mobile robot 42 when the congestion level satisfies a threshold value. The space sharing situation may include a congestion situation and a collision situation that may occur as a result of the plurality of mobile robots sharing the same space (e.g., the moving space 410 of FIG. 4A and the stationary space 430 of FIG. 4B). When congestion and/or a collision due to sharing the space with the second mobile robot 42 is expected, the first mobile robot 41 may detect that the space sharing situation with the second mobile robot 42 has occurred. The first mobile robot 41 may detect the second mobile robot 42 that shares the space with the first mobile robot 41.

In operation 502, the first mobile robot 41 may share information of an identifier with the second mobile robot 42. The first mobile robot 41 may obtain information on the second mobile robot 42 by exchanging the identifier with the second mobile robot 42. The first mobile robot 41 may directly interwork with the second mobile robot 42. The first mobile robot 41 may share the information of the identifier with the second mobile robot 42 by directly interworking with the second mobile robot 42.

In operation 503, the first mobile robot 41 may transmit a status of the first mobile robot 41 to the first service provider 51. The first mobile robot 41 may notify the first service provider 51 of an occurrence of the space sharing situation with the second mobile robot 42, together with an identifier for the second mobile robot 42.

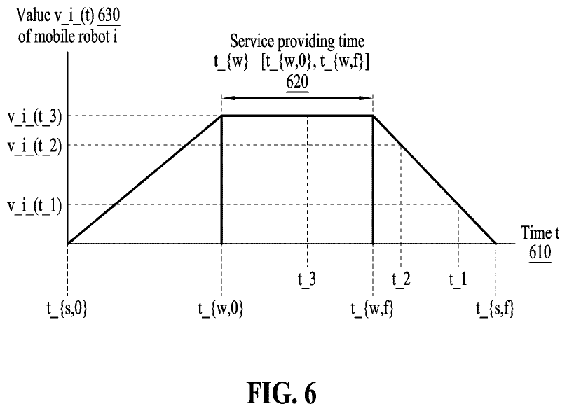

In operation 504, the first service provider 51 may recognize the space sharing situation and derive a value function. The first service provider 51 may recognize the space sharing situation based on the status of the first mobile robot 41 received from the first mobile robot 41. The first service provider 51 may derive a first value function corresponding to the first mobile robot 41. The first value function may be determined based on a service providing time of the first mobile robot 41. The value function is described below in more detail with reference to FIG. 6.

In operation 505, the first service provider 51 may determine the consensus policy corresponding to the first mobile robot 41. The first service provider 51 may determine the first consensus policy corresponding to the first mobile robot 41. The consensus policy may include a policy regarding a consensus decision (e.g., a priority consensus decision regarding an order of movement) with another mobile robot in a space sharing situation with the another mobile robot. The consensus policy (e.g., the first consensus policy and the second consensus policy) may include a cooperation policy and a competition policy. The cooperation policy may be a policy by which the service providers (e.g., the first service provider 51 and the second service provider 52) agree to agree on a priority related to the order of movement between a mobile robot (e.g., the first mobile robot 41) and another mobile robot (e.g., the second mobile robot 42) that shares a space with the mobile robot (e.g., the first mobile robot 41). The competition policy may be a policy by which the service providers (e.g., the first service provider 51 and the second service provider 52) agree to disagree on the priority related to the order of movement between the first mobile robot 41 and the second mobile robot 42 that shares a space with the first mobile robot 41. It should be noted that the cooperation policy and the competition policy are only examples of the consensus policy, and the types of consensus policy are not limited thereto. The first service provider 51 may determine the first consensus policy of the first mobile robot 41 based on the first value function corresponding to the first mobile robot 41. For example, the first service provider 51 may determine, based on the first value function, the first consensus policy of the first mobile robot 41 to be the cooperation policy or the competition policy. The first service provider 51 may determine the first consensus policy to be the cooperation policy or the competition policy based on information (e.g., a type of service and the service providing time) on a service to be provided by the first mobile robot 41.

In operation 506, the first service provider 51 may exchange the consensus policies with the second service provider 52. The first service provider 51 may exchange the first consensus policy of the first mobile robot 41 for the second consensus policy of the second mobile robot 42.

In operation 507, the first service provider 51 may recognize consensus policies of all mobile robots. For example, the first service provider 51 may recognize the second consensus policy of the second mobile robot 42 received from the second service provider 52 and the first consensus policy of the first mobile robot 41.

In operation 508, the first service provider 51 may determine whether the first consensus policy and the second consensus policy are the cooperation policy. When the first service provider 51 determines that the first consensus policy and the second consensus policy are the cooperation policy, the first service provider 51 may determine the moving method of the first mobile robot 41 to be a first moving method and perform operation 511. The first moving method may be based on the priority related to the order of movement between the first mobile robot 41 and the second mobile robot 42. When the first service provider 51 determines that both of the first consensus policy and the second consensus policy are not the cooperation policy (e.g., when the first service provider 51 determines that at least one of the first consensus policy and the second consensus policy is the competition policy), the first service provider 51 may determine the moving method of the first mobile robot 41 to be a second moving method. The second moving method may be a moving method in which the first mobile robot 41 and the second mobile robot 42 do not agree on the order of movement and each independently determine a behavior. When the moving method of the first mobile robot 41 is determined to be the second moving method, the first service provider 51 may transmit, to the first mobile robot 41, movement information (e.g., delivery information) that the first service provider 51 generates independently without considering the second mobile robot 42.

In operation 509, the first mobile robot 41 may determine whether the space sharing situation has been detected. The first mobile robot 41 may behave based on the movement information generated by the first service provider 51 and may determine again whether a space sharing situation has occurred. When detecting that a space sharing situation has occurred, the first mobile robot 41 may perform operations again, starting with operation 501. When the first mobile robot 41 does not detect a space sharing situation, the first mobile robot 41 may transmit the status of the first mobile robot 41 to the first service provider 51 (i.e., perform operation 510) and terminate the operation.

In operation 511, the first service provider 51 and the second service provider 52 may share the service providing time information and the value function. The first service provider 51 may exchange the service providing time information of the first mobile robot 41 for service providing time information of the second mobile robot 42 of the second service provider 52. The first service provider 51 may exchange the first value function corresponding to the first mobile robot 41 for a second value function corresponding to the second mobile robot 42 of the second service provider 52. The second value function may correspond to the second mobile robot 42 and may be derived by the second service provider 52.

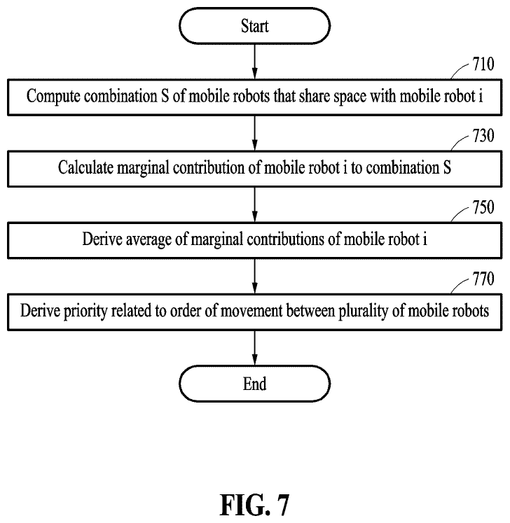

In operation 512, the first service provider 51 may derive the priority related to the order of movement between the first mobile robot 41 and the second mobile robot 42. The operation of deriving the priority, performed by the first service provider 51, is described below in detail with reference to FIG. 7.

In operation 513, the first service provider 51 may confirm the priority in a relationship with the second service provider 52. The first service provider 51 may confirm the derived priority of the first mobile robot 41 and the derived priority of the second mobile robot 42. Each service provider may confirm the priority of all mobile robots and determine the priority of the mobile robot the service provider operates.

In operation 514, the first service provider 51 may transmit the priority to the first mobile robot 41. The first service provider 51 may transmit the priority to the first mobile robot 41 to control the movement of the first mobile robot 41 according to the first moving method.

In operation 515, the first mobile robot 41 may recognize the priority received from the first service provider 51 and behave according to the priority. The first mobile robot 41 may control its own movement based on the priority received from the first service provider 51. The first movement robot 41 may be controlled to move according to the first moving method based on the priority related to the order of movement between the first movement robot 41 and the second movement robot 42.

In operation 516, the first mobile robot 41 may transmit the status of the first mobile robot 41 to the first service provider 51. Since the first mobile robot 41 may have moved according to the first moving method, the space sharing situation may be resolved. The first mobile robot 41 may notify the first service provider 51 that the first mobile robot 41 has resolved the space sharing situation.

In operation 517, the first service provider 51 may confirm that the situation (e.g., the space sharing situation) has been resolved and terminate the operation.

FIG. 6 is a diagram illustrating a value function according to an embodiment.

Referring to FIG. 6, the value function may be a function for deriving a value of a mobile robot. FIG. 6 illustrates an example of a graph to describe a value v_i_(t) 630 of a mobile robot i (here, i is a natural number greater than or equal to 1) according to a time t 610. It should be noted that the value v_i_(t) 630 of the mobile robot i according to the time t 610 is not limited to the derivation by the graph shown in FIG. 6.

The value function may include a first value function and a second value function. The first value function and the second value function may be value functions corresponding to a first mobile robot (e.g., the first mobile robot 41 of FIG. 5) and a second mobile robot (e.g., the second mobile robot 42), respectively. The first value function and the second value function may be the same value function or different value functions.

A value (e.g., a first value) of the mobile robot i (e.g., the first mobile robot 41) may be determined based on a user's satisfaction level according to a service providing time of the mobile robot i and a value function (e.g., the first value function) corresponding to the mobile robot i. A service providing time (e.g., a service providing time 620) may be a time duration that may include a time duration during which the mobile robot i (e.g., the first mobile robot 41) is expected to provide a service (e.g., delivering goods and cleaning). The service providing time may refer to a specific time duration (e.g., n minutes) within which a service according to a request of a user may need to start or finish. The service providing time 620 may vary for each mobile robot. For example, the service providing time 620 may vary depending on a status of each mobile robot and a type of service provided by each mobile robot. The service providing time 620 may vary depending on a content (e.g., a type of service and a type of goods) of a service provision request from a user device. For example, when the mobile robot i is a delivery robot (e.g., the delivery robot 11), the service providing time 620 may include a time to load and/or unload goods that a user requested to deliver. In another example, when the mobile robot i is a cleaning robot capable of providing a cleaning service, the service providing time 620 may include an available cleaning time.

According to an embodiment, a service providing time may include a time duration during which the user's satisfaction level with the service provided by the mobile robot i is highest. The value (e.g., first value) of the mobile robot i may be highest at the service providing time (e.g., the service providing time 620). For example, the value v_i_(t) 630 of the mobile robot i may be the highest during the service providing time 620, which may be from a time t_{w,0} to a time t_{w,f}. Since the service providing time 620 may be the time during which the mobile robot i is expected to provide a service, the user's satisfaction level may be highest during the service providing time 620. The value v_i_(t) 630 of the mobile robot i may vary depending on the user's satisfaction level. For example, when the mobile robot i provides the service too early (e.g., when providing the service in a time duration from a time t_{s,0} to the time t_{w,0}) or too late (e.g., when providing the service after the time t_{w,f}), the value v_i_(t) 630 of the mobile robot i may decrease as the satisfaction level of a user receiving the service may decrease.

FIG. 7 is a diagram illustrating an operation of deriving a priority, according to an embodiment.

Referring to FIG. 7, operations 710 to 770 may be substantially the same as operation 512 described with reference to FIG. 5. A service provider (e.g., the first service provider 51) that manages a mobile robot (e.g., the first mobile robot 41 of FIG. 5) may derive priority related to an order of movement between a plurality of mobile robots. For example, the first service provider 51 may derive priority related to an order of movement between the first mobile robot 41 and the second mobile robot 42. Operations 710 to 770 regarding deriving the priority related to an order of movement between a plurality of mobile robots may be performed by a processor (e.g., the processor 920 of FIG. 9) included in each mobile robot. Hereinafter, operations 710 to 770 are described under the assumption that the operations are performed by a service provider (e.g., the first service provider 51), but embodiments are not limited thereto.

In operation 710, the first service provider 51 may compute a combination S of mobile robots (e.g., the second mobile robot 42) that share a space with the mobile robot i (e.g., the first mobile robot 41). The combination S of mobile robots may include a combination of one or more mobile robots (e.g., the second mobile robot 42) that share a space (e.g., the moving space 410 of FIG. 4A and the stationary space 430 of FIG. 4B) with the first mobile robot 41. For example, the combination S may include a combination of a plurality of mobile robots that shares a space with the first mobile robot 41 as a subset of a total set N of a plurality of mobile robots.

In operation 730, the first service provider 51 may calculate a marginal contribution of the mobile robot i (e.g., the first mobile robot 41) to the combination S. The marginal contribution of the mobile robot i to the combination S may refer to a difference in the value of the mobile robot i between when the mobile robot i is in the combination S and when the mobile robot i is not in the combination S. For example, the marginal contribution may include a Shapley value. The first service provider 51 may calculate the marginal contribution based on a value function corresponding to each mobile robot. The first service provider 51 may calculate the marginal contribution of the mobile robot i based on a value of each mobile robot according to the value function. The first service provider 51 may calculate the marginal contribution of the mobile robot i to the combination S based on Equation 1 below.

$${φ}_{i} ( v ) = \frac{1}{\vert N \vert} {\sum }_{S ⊆ N - \{ i \}} {( \begin{matrix}\vert N \vert - 1 \\ \vert S \vert\end{matrix} )}^{- 1} ( v ( S ⋃ \{ i \} ) - v ( S ) ) = {\sum }_{S ⊆ N \backslash \{ i \}} \frac{\vert S \vert ! \cdot ( \vert N \vert - \vert S \vert - 1 ) !}{\vert N \vert !} ( v ( S ⋃ \{ i \} ) - v ( S ) ) \qquad [ Equation 1 ]$$

Here, φᵢ(v) denotes the marginal contribution of the mobile robot i, N denotes the set of the plurality of mobile robots, v(S) denotes a value generated by a coalition of the mobile robots included in the combination S, and v (S∪{i})−v(S) denotes the value contributed to the combination S by the mobile robot i.

In operation 750, the first service provider 51 may derive an average of marginal contributions of the mobile robot i to the combination S. For example, for the combination S, which includes a plurality of combinations, of one or more mobile robots that share a space with the mobile robot i, the first service provider 51 may calculate a marginal contribution of the mobile robot i to each of the plurality of combinations and derive an average of the marginal contributions. The first service provider 51 may derive priority based on the average of the marginal contributions of the mobile robot i. For example, a mobile robot with a higher marginal contribution may be determined to have a higher priority.

In operation 770, the first service provider 51 may derive the priority related to an order of movement between a plurality of mobile robots. The first service provider 51 may determine the priority related to an order of movement between the first mobile robot 41 and the second mobile robot 42 based on a first value function corresponding to the first mobile robot 41 and a second value function corresponding to the second mobile robot 42. The first service provider 51 may determine the priority based on a first value of the first mobile robot 41 according to the first value function and a second value of the second mobile robot 42 according to the second value function. The priority may be determined so that a sum of the first value and the second values may be maximized.

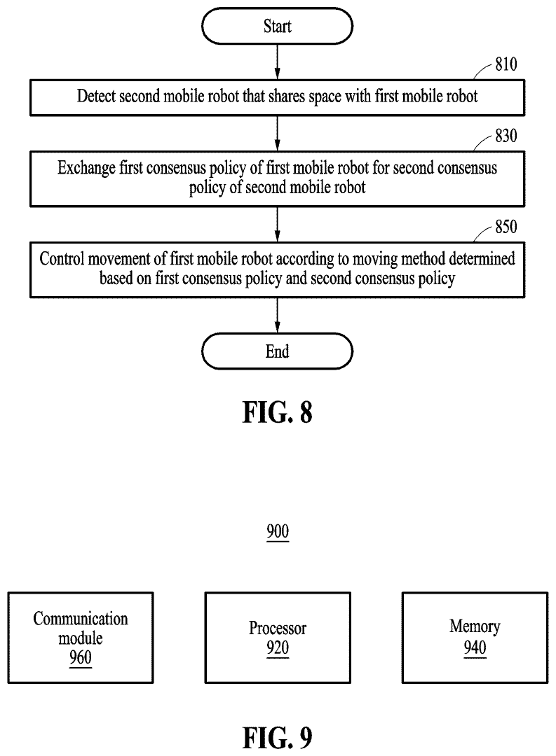

FIG. 8 is a flowchart illustrating a method of controlling movement of a mobile robot, according to an embodiment.

Referring to FIG. 8, operations 810 to 850 may be substantially the same as the method of controlling movement of a mobile robot described with reference to FIGS. 1 to 7. An apparatus (e.g., an apparatus 1100 of FIG. 11) that performs the method of controlling movement of a mobile robot may include a device (e.g., a server) of a service provider. The apparatus 1100 may be mounted on a mobile robot to control movement of the mobile robot.

In operation 810, the apparatus 1100 may detect a second mobile robot that shares a space with a first mobile robot. In response to detecting a space sharing situation of the first mobile robot (e.g., the first mobile robot 41), the apparatus 1100 may detect the second mobile robot (e.g., the second mobile robot 42) that shares the space with the first mobile robot 41.

In operation 830, the apparatus 1100 may exchange the first consensus policy of the first mobile robot 41 for the second consensus policy of the second mobile robot 42. Operation 830 may be substantially the same as operation 506 described with reference to FIG. 5. Accordingly, a repeated description thereof is omitted.

In operation 850, the apparatus 1100 may control movement of the first mobile robot 41 according to a moving method determined based on the first consensus policy and the second consensus policy. The moving method may be determined to be a first moving method when the first consensus policy and the second consensus policy are cooperation policies. The apparatus 1100 may determine the moving method to be a second moving method when at least one of the first consensus policy and the second consensus policy is a competition policy. The apparatus 1100 may control the movement of the first mobile robot 41 according to the determined moving method.

Operations 810 to 850 may be performed sequentially, but embodiments are not limited thereto. For example, two or more operations may be performed in parallel.

FIG. 9 is a block diagram schematically illustrating a mobile robot according to an embodiment.

Referring to FIG. 9, a mobile robot 900 (e.g., the first mobile robot 41 and the second mobile robot 42 of FIG. 5 and the delivery robot 11 of FIG. 1) may include the processor 920, a memory 940, and a communication module 960.

The memory 940 may store instructions (or programs) executable by the processor 920. For example, the instructions may include instructions for executing an operation of the processor 920 and/or an operation of each component of the processor 920.

The memory 940 may include one or more pieces of computer-readable storage media. The memory 940 may include non-volatile storage elements (e.g., a magnetic hard disk, an optical disc, a floppy disc, flash memory, erasable programmable read-only memory (EPROM), and electrically erasable programmable read-only memory (EEPROM)).

The memory 940 may be a non-transitory medium. The term “non-transitory” may indicate that the storage medium is not embodied in a carrier wave or a propagated signal. However, the term “non-transitory” should not be interpreted to mean that the memory 940 is non-movable.

The processor 920 may process data stored in the memory 940. The processor 920 may execute computer-readable code (e.g., software) stored in the memory 940 and instructions triggered by the processor 920.

The processor 920 may be a hardware-implemented data processing device having a circuit that is physically structured to execute desired operations. The desired operations may include, for example, instructions or code included in a program.

The hardware-implemented data processing device may include, for example, a microprocessor, a central processing unit (CPU), a processor core, a multi-core processor, a multiprocessor, an ASIC, and an FPGA.

The processor 920 may cause the mobile robot 900 to perform one or more operations by executing the code, instructions, and/or applications stored in the memory 940. Operations performed by the mobile robot 900 may be substantially the same as the operations performed by the first mobile robot 41 (e.g., the delivery robot 11) described with reference to FIGS. 1 to 8. Accordingly, a repeated description thereof is omitted.

The communication module 960 may establish a communication channel (e.g., a wireless communication channel) for communication. The communication module 960 may support the communication through the established communication channel. The communication module 960 may include one or more communication processors configured to support direct (or wired) communication or wireless communication. The communication module 960 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module).

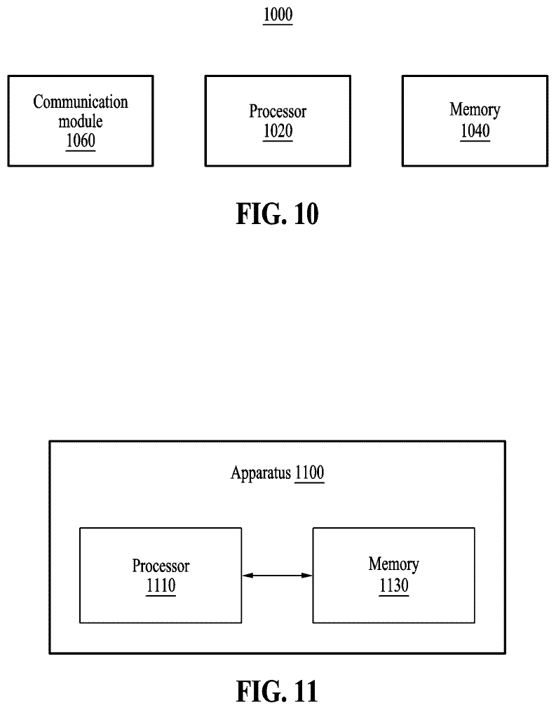

FIG. 10 is a block diagram schematically illustrating a service provider according to an embodiment.

Referring to FIG. 10, a service provider 1000 (e.g., the first service provider 51 and the second service provider 52 of FIG. 5 and the delivery robot service provider 17 of FIG. 1) may include a processor 1020, a memory 1040, and a communication module 1060.

The memory 1040 may store instructions (or programs) executable by the processor 1020. For example, the instructions may include instructions for executing an operation of the processor 1020 and/or an operation of each component of the processor 1020.

The memory 1040 may include one or more pieces of computer-readable storage media. The memory 1040 may include non-volatile storage elements (e.g., a magnetic hard disk, an optical disc, a floppy disc, flash memory, EPROM, and EEPROM).

The memory 1040 may be a non-transitory medium. The term “non-transitory” may indicate that the storage medium is not embodied in a carrier wave or a propagated signal. However, the term “non-transitory” should not be interpreted to mean that the memory 1040 is non-movable.

The processor 1020 may process data stored in the memory 1040. The processor 1020 may execute computer-readable code (e.g., software) stored in the memory 1040 and instructions triggered by the processor 1020.

The processor 1020 may be a hardware-implemented data processing device having a circuit that is physically structured to execute desired operations. The desired operations may include, for example, instructions or code included in a program.

The hardware-implemented data processing device may include, for example, a microprocessor, a CPU, a processor core, a multi-core processor, a multiprocessor, an ASIC, and an FPGA.

The processor 1020 may cause the service provider 1000 to perform one or more operations by executing the code, instructions, and/or applications stored in the memory 1040. Operations performed by the service provider 1000 may be substantially the same as the operations performed by the first service provider 51 (e.g., the delivery robot service provider 17 of FIG. 1) described with reference to FIGS. 1 to 8. Accordingly, a repeated description thereof is omitted.

The communication module 1060 may establish a communication channel (e.g., a wireless communication channel) for communication. The communication module 1060 may support the communication through the established communication channel. The communication module 1060 may include one or more communication processors configured to support direct (or wired) communication or wireless communication. The communication module 1060 may include a wireless communication module (e.g., a cellular communication module, a short-range wireless communication module, or a GNSS communication module) or a wired communication module (e.g., a LAN communication module or a PLC module).

FIG. 11 is a block diagram schematically illustrating an apparatus for controlling movement of a mobile robot, according to an embodiment.

Referring to FIG. 11, the apparatus 1100 may include a processor 1110 and a memory 1130. The apparatus 1100 may be mounted on a mobile robot (e.g., the first mobile robot 41 of FIG. 5 and the mobile robot 900 of FIG. 9) to control movement of the mobile robot. The apparatus 1100 may include a device (e.g., a server) of a service provider (e.g., the first service provider 51 of FIG. 5 and the service provider 1000 of FIG. 10).

The memory 1130 may store instructions (or programs) executable by the processor 1110. For example, the instructions may include instructions for executing an operation of the processor 1110 and/or an operation of each component of the processor 1110.

The memory 1130 may include one or more pieces of computer-readable storage media. The memory 1130 may include non-volatile storage elements (e.g., a magnetic hard disk, an optical disc, a floppy disc, flash memory, EPROM, and EEPROM).

The memory 1130 may be a non-transitory medium. The term “non-transitory” may indicate that the storage medium is not embodied in a carrier wave or a propagated signal. However, the term “non-transitory” should not be interpreted to mean that the memory 1130 is non-movable.

The processor 1110 may process data stored in the memory 1130. The processor 1110 may execute computer-readable code (e.g., software) stored in the memory 1130 and instructions triggered by the processor 1110.

The processor 1110 may be a hardware-implemented data processing device having a circuit that is physically structured to execute desired operations. The desired operations may include, for example, instructions or code included in a program.

The hardware-implemented data processing device may include, for example, a microprocessor, a CPU, a processor core, a multi-core processor, a multiprocessor, an ASIC, and an FPGA.

The processor 1110 may cause the apparatus 1100 to perform one or more operations by executing the code, instructions, and/or applications stored in the memory 1130. Operations performed by the apparatus 1100 may be substantially the same as the method of controlling movement of a mobile robot according to an embodiment described with reference to FIGS. 1 to 11. Accordingly, a repeated description thereof is omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be stored in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described examples. The media may also include the program instructions, data files, data structures, and the like alone or in combination. The program instructions recorded on the media may be those specially designed and constructed for the embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described embodiments, or vice versa.

Although the embodiments have been described with reference to the limited number of drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method comprising:
detecting a second mobile robot that shares a space with a first mobile robot;
exchanging a first consensus policy of the first mobile robot for a second consensus policy of the second mobile robot; and
controlling movement of the first mobile robot according to a moving method determined based on the first consensus policy and the second consensus policy.

2. The method of claim 1, wherein the exchanging of the first consensus policy for the second consensus policy comprises:
determining whether the first consensus policy and the second consensus policy are a cooperation policy.

3. The method of claim 2, wherein the moving method is
determined to be a first moving method when the first consensus policy and the second consensus policy are the cooperation policy; and
determined to be a second moving method when at least one of the first consensus policy and the second consensus policy is a competition policy.

4. The method of claim 3, wherein the first moving method is based on priority related to an order of movement between the first mobile robot and the second mobile robot.

5. The method of claim 4, wherein the priority is determined based on a first value function corresponding to the first mobile robot and a second value function corresponding to the second mobile robot.

6. The method of claim 5, wherein
the first value function is determined based on a service providing time of the first mobile robot, and
the second value function is determined based on a service providing time of the second mobile robot.

7. The method of claim 5, wherein the priority is determined based on a first value of the first mobile robot according to the first value function and a second value of the second mobile robot according to the second value function.

8. The method of claim 7, wherein
the first value is determined based on a user's satisfaction level according to a service providing time of the first mobile robot and the first value function, and
the second value is determined based on a user's satisfaction level according to a service providing time of the second mobile robot and the second value function.

9. The method of claim 7, wherein the priority is determined so that a sum of the first value and the second value is maximized.

10. A non-transitory computer-readable storage medium storing instructions that, when executed by a processor, cause the processor to perform the method of claim 1.

11. An apparatus comprising:
a memory comprising instructions; and
a processor electrically connected to the memory and configured to execute the instructions,
wherein, when the instructions are executed by the processor, the processor is configured to control a plurality of operations,
wherein the plurality of operations comprises:
detecting a second mobile robot that shares a space with a first mobile robot;
exchanging a first consensus policy of the first mobile robot for a second consensus policy of the second mobile robot; and
controlling movement of the first mobile robot according to a moving method determined based on the first consensus policy and the second consensus policy.

12. The apparatus of claim 11, wherein the exchanging of the first consensus policy for the second consensus policy comprises:
determining whether the first consensus policy and the second consensus policy are a cooperation policy.

13. The apparatus of claim 12, wherein the moving method is
determined to be a first moving method when the first consensus policy and the second consensus policy are the cooperation policy; and
determined to be a second moving method when at least one of the first consensus policy and the second consensus policy is a competition policy.

14. The apparatus of claim 13, wherein the first moving method is based on priority related to an order of movement between the first mobile robot and the second mobile robot.

15. The apparatus of claim 14, wherein the priority is determined based on a first value function corresponding to the first mobile robot and a second value function corresponding to the second mobile robot.

16. The apparatus of claim 15, wherein
the first value function is determined based on a service providing time of the first mobile robot, and
the second value function is determined based on a service providing time of the second mobile robot.

17. The apparatus of claim 15, wherein the priority is determined based on a first value of the first mobile robot according to the first value function and a second value of the second mobile robot according to the second value function.

18. The apparatus of claim 17, wherein
the first value is determined based on a user's satisfaction level according to a service providing time of the first mobile robot and the first value function, and
the second value is determined based on a user's satisfaction level according to a service providing time of the second mobile robot and the second value function.

19. The apparatus of claim 17, wherein the priority is determined so that a sum of the first value and the second value is maximized.
